(19) United States
(12) Patent Application Publication
(10) Pub. No.: US 2004/0083196 A1
(43) Pub. Date: Apr. 29, 2004

(54) Hardware property management system and method

(76) Inventors: Jason Reasor, Frisco, TX (US); Bradley G. Culter, Dallas, TX (US); David Soper, Murphy, TX (US)

Correspondence Address: HEWLETT-PACKARD COMPANY, Intellectual Property Administration, P.O. Box 272400, Fort Collins, CO, 80527-2400, US

(21) Appl. No.: 10/282,587

(22) Filed: Oct. 29, 2002

(51) Int. Cl. G06F 7/00

(52) U.S. Cl. 707/1

(57) ABSTRACT

A system and method is disclosed for managing a plurality of hardware properties in a component-based system comprising representing the plurality of hardware properties using a data-descriptive meta-language, and making the hardware properties available to client devices according to the data-descriptive meta-language.

### DESCRIPTION OF RELATED ART

In a computing system with a large amount of memory, such as a server, the memory is usually arranged in a hierarchy. There is generally a need to have a complex descriptive function for the memory arrangement. Presently, hardware attributes and properties, such as the memory properties, are usually described in a data structure coded in some computer language, such as C, C++, or the like, having a number of fields equal to the number of properties to be described. For example, a memory node may be described by its address and type. (“Node” is a generic term that refers to a group of hardware devices that perform a function on a subsystem level.) The data structure would generally have two fields, one to hold information about the address and one to hold information about the memory type.

Because the size and attributes of a typical data structure are generally fixed at initialization, if the user would like to later add a new memory node of a different size, the data structure would need to be changed to accommodate a third field for a new size. This means that the data structure would have to be recoded. It also means that anything that uses the information from the data fields (generally called, “consumers”) would have to be recoded so that they can use the information. Furthermore, the programs that translate the data for the consumer are usually proprietary and unique, such that if a user of one of these complex computing systems would like to access the information in the device tree, he would have to acquire a custom or proprietary translator.

### BRIEF SUMMARY OF THE INVENTION

Embodiments are directed to a method for managing a plurality of hardware properties in a component-based system comprising representing the plurality of hardware properties using a data-descriptive meta-language, and making the hardware properties available to client devices according to the data-descriptive meta-language.

Additional embodiments are directed to a system for administration of devices connected to a multi-device electronic assembly comprising a memory comprising a device tree for arranging properties corresponding to the devices, where the properties are recorded in a data-descriptive computer language, and a client interface for facilitating communication of the properties to clients of the multi-device electronic assembly.

Further embodiments are directed to a system for administrating a plurality of device properties in a component-based system comprising the steps of means for representing the plurality of device properties using a data-descriptive language, and means for making the device properties available to clients according to the data-descriptive language.

### BRIEF DESCRIPTION OF THE DRAWINGS

FIG. 1 is an illustration of two cells that may be used in complex computing devices;

FIG. 2 is a diagram of the structure of a database that is used to store hardware properties;

FIG. 3 is a representation according to one embodiment as disclosed herein of hardware properties as they might be organized in XML;

FIG. 4 is a graphical representation constructed according to one embodiment as disclosed herein of hardware properties as presented in FIG. 3 with an added property; and

FIG. 5 is a flowchart illustrating an embodiment as described herein.

### DETAILED DESCRIPTION

Computing systems are made up of many different components. Hardware may communicate with other hardware, which may communicate with software, which may eventually communicate with a user. Hardware may comprise external, peripheral devices, internal devices, or even internal parts or components. Software may comprise code stored onto a hard disk, CD-ROM, or other such memory device, and may also include firmware stored on read-only memory (ROM) or other such memory devices. In order to assemble and maintain this conglomeration of equipment, components, and software as an actual computer system, there is typically software that enables all of the hardware and software to communicate with each other in a logical and predictable manner. Much of this system software is stored as firmware in a computer's ROM or solid-state memory.

When a computer is turned on, it typically requires basic software programs that can be accessed immediately upon powering-on. Firmware generally serves the computing system in such a way. System firmware is generally comprised of the most basic programs in the computer system, and it is usually the platform upon which the operating system is supported. It is typically stored in ROM in an address accessible by a CPU upon power-up. One of its many duties is to initialize the computer by starting the operating system and configuring the system hardware. Hardware can be any physical part of the computing system and includes, among other things, the CPU, memory, and any peripheral devices that may be externally connected. Configuration is accomplished when the system firmware identifies connected hardware and queries the hardware to determine the hardware properties. Once this information is found, the properties are then reported back to the system, thereby establishing what hardware is connected to the system. The computing system generally arranges this information along with information from other hardware into a database. Once the hardware is described in the database, it is usually ready to be used by the system. After initialization is completed, the system firmware is generally used as an interface between the computing system's hardware, such as its processors, and its operating system so that the operating system need not control the system hardware directly, but rather the operating system communicates to the firmware, which, in turn, controls the system hardware.

A firmware programmer typically codes the firmware to fill a database in scratch RAM during configuration. That scratch RAM may hold information about the hardware devices as they are discovered. Typically, once memory has been initialized and is available for use by the system, the scratch RAM database may be moved to memory. Such databases may be in a tree format, and the hardware may be represented in the database by its descriptive properties and attributes. This hardware properties' database is commonly called a “device tree.” The descriptive properties and attributes generally use internal proprietary names and formats so that compatible software may query the device tree in preparation for using the hardware.

In the realm of complex computing systems the firmware describes the hardware precisely enough so that the hardware may be recognized and utilized by the system. As a result, when hardware properties are changed, system applications or other consumer or client devices and applications that process hardware descriptions might also have to be changed in order to keep the system operating. Consumer or client devices and applications may comprise different hardware or software that works with the system and needs the hardware properties in order to properly interact with the system. The necessary recoding in current systems is especially a concern when proprietary or unique firmware is used because proprietary firmware often may not comply with a standard that applies to every permutation of available hardware devices. Hardware changes may therefore require extensive recoding throughout the system. An example of a complex computing system is a server that may contain many cells. Cells are similar to motherboards, in that they are printed circuit boards with processors and other hardware mounted thereon. A cache coherency controller (an integrated circuit that arbitrates communication between the CPUs and the other hardware on the particular cell) may be located on each cell, as well as several CPUs, several memory regions, and a power converter. Each memory region may be made up of many dual inline memory modules (DIMMs). Accordingly, each cell may contain significant hardware that typically needs to be described by the firmware, and the system as a whole contains much more hardware. If each component that processes hardware descriptions needs to be recoded each time a hardware description changes, then the amount of recoding can become quite large in a complex computing system.

Extensible Markup Language (XML) is a text-based, standard mark-up language that not only allows for the description of data but also allows for the description of the structure of that data. It is a subset of Standard Generalized Markup Language (SGML), as is its more well-known relative, Hypertext Markup Language (HTML). While HTML is generally limited to describing the format and visual description of data for displaying documents in a browser, XML is much more flexible because it allows a user to describe data in an unlimited number of ways. Thus, HTML is often referred to as a “format-descriptive meta-language” while XML is often referred to as a “data-descriptive meta-language.”

XML is slightly different than a conventional computer language in that it is a standard capable of creating languages, allowing a user to pick his own syntax for describing data. For example, if a user wants to create a field that contains information about a name, he may designate the field be named, “<name>,” and may enter into the field any variation of the name that he wishes. A program that understands or is able to parse XML would generally be able to see that there is a field named, “name,” and that information is contained in that field. That quality is at the heart of the advantages of XML—the ability to describe one's own data in a way that one chooses. Currently, XML is gaining popularity as a tool to represent data in web site content, though that is not its only application. It may also be used to facilitate remote procedure calls (RPCs), which are a way to distribute computing workload between computing devices. Because of its ability to describe the structure of information, it is also being used to reduce server workload by aggregating information into a large XML file that may be sent to many servers.

XML generally allows data to be structured so that an application that understands or can parse XML may pull out desired bits of information while ignoring other information. For example, if a person is described in an XML document by height, hair color, and sex, an application that only needs information about height may generally pick out the information labeled, “height” and ignore the rest of the information. This allows an XML user to modify the information in the three fields typically without having to recode the applications that use the information. It also usually allows the user to add another field to the document, such as hair length, without having to recode software to interpret the original information. This ability to describe information in numerous ways and the flexibility with which data may be retrieved is often referred to as the quality of being “extensible.” Furthermore, XML typically allows information to be arranged into hierarchies and/or trees, which suits some kinds of data very well. Additionally, XML is a standard data-description language, which means that as long as users employ the same standard means and/or vocabulary to describe the information, those users should generally be able to understand and access any information stored in any XML document.

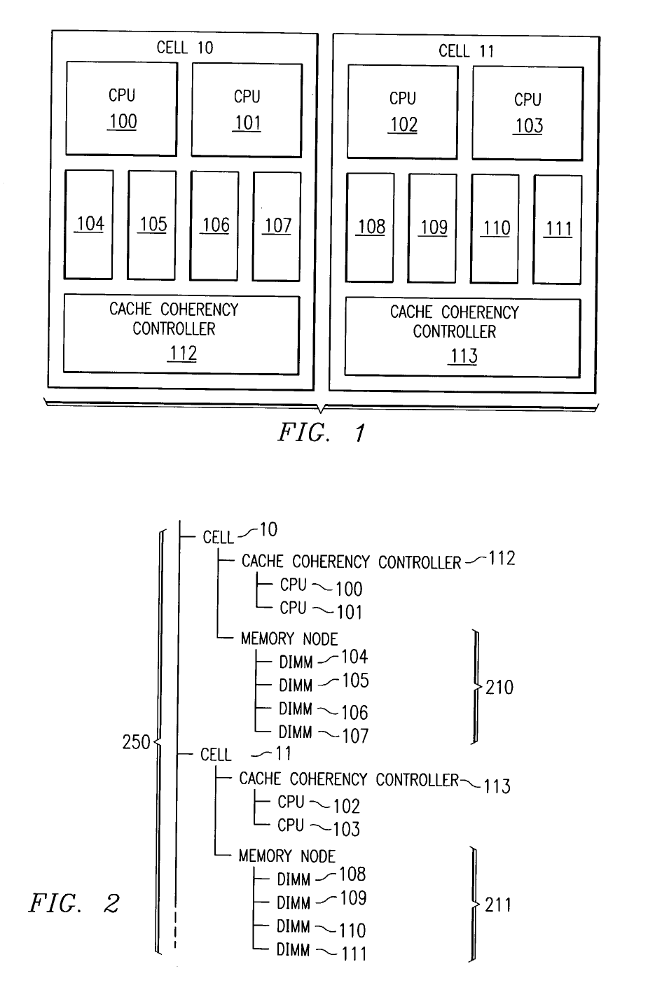

FIG. 1 is an illustration of two cells that may be used in complex computing devices. FIG. 1 shows two cells, cell 10 and cell 11. On each of cell 10 and cell 11, there may be several central processing units (CPUs) 100, 101, 102, 103, several dual inline memory modules (DIMMs) 104, 105, 106, 107, 108, 109, 110, 111, cache coherency controllers (CCC) 112, 113 and other components, such as power (not shown). These and other cells may be plugged into a large backplane to comprise a large system server or creating a multi-device electronic assembly. The server or device assembly may also be connected to an input/output device. Servers typically have up to 128 or more CPUs and several DIMMs per CPU. CPUs and DIMMs are merely examples of the many different types of hardware components that may be described in device tree 250 of FIG. 2.

FIG. 2 is a diagram of the structure of a database that is used to store hardware properties. FIG. 2 represents a section of device tree 250 that stores information about cell 10 and cell 11. The information is in a hierarchical tree format structure such that cell 10 is shown to consist of CCC 112 with CPUs 100, 102 connected thereto and memory node 210 comprising DIMMs 104, 105, 106, 107. Cell 11 is shown, in a like manner, with a corresponding hardware configuration. At their most basic levels, cells 10 and 11 consist of CCC 112 and 113; CPUs 100, 101, 102 and 103; and DIMMs 104, 105, 106, 107, 108, 109, 110, and 111. Therefore, there may be many hardware components per cell, and many cells per server. Any such other components would also be shown in device tree 250.

When firmware identifies hardware in the system through a device interface, it may create device tree 250, which is a listing of all the hardware components and the properties for those components in each cell in the system, by various methods, such as transmitting a polling signal to each device detected on the system, configuring the system for the devices to automatically send its properties to the system on being attached to the system, implementing a reader program to systematically search each attached device for the device properties, or other such process. For example, cell 10 contains CCC 112, which is connected to CPUs 100 and 101. Each CPU has several properties, such as frequency, model number, and the like. These properties are stored in device tree 250 under each of CPU 100, 101, 102, and 103. Accordingly, the properties of each cell are stored under that respective cell in device tree 250. Notice also in FIG. 2 that all of the memory components 104, 105, 106, 107, 108, 109, 110, and 111 are listed directly under memory nodes 210 and 211 respectively; however, this does not have to be the case. For example, memory subregions could reside under memory nodes 210 and 211, and each subregion could consist of several memory components or could be divided even further. Also, properties do not have to be listed under the lowest level of the hierarchy only. For example, each of CCC 112 and 113; memory nodes 210 and 211; or memory subregions could also have properties listed.

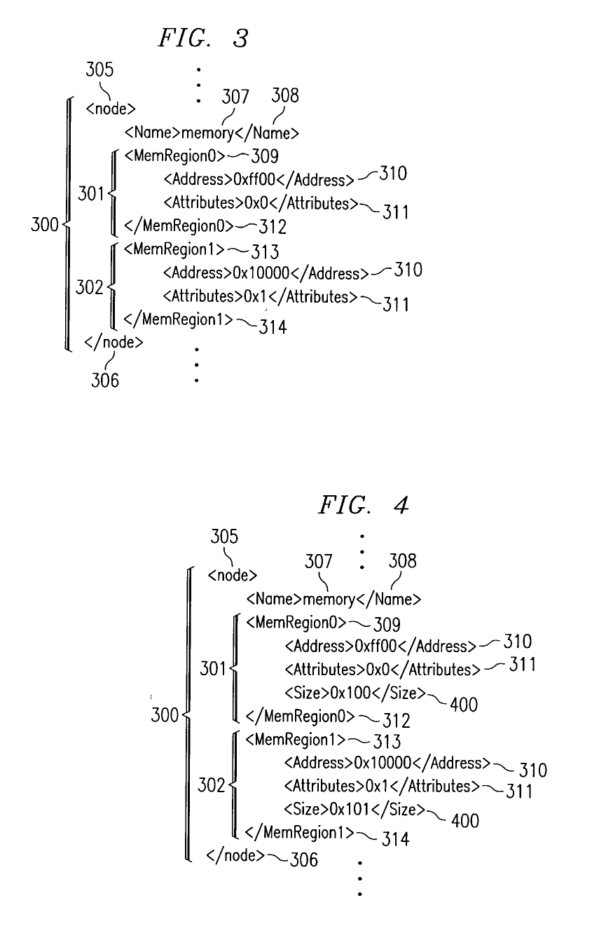

FIG. 3 is a representation according to one embodiment as disclosed herein of hardware properties as they might be organized in XML. Memory node 300 is similar to other memory nodes that might reside on cells 10 and 11 (FIG. 1). FIG. 3 shows only a single exemplary representation of one memory node, node 300; in practice, device trees, such as device tree 250 in FIG. 2, may be much larger, including other hardware in addition to memory nodes, and may have more levels in the hierarchy. In this particular representation, memory node 300 is the highest level of the hierarchy, though, in practice, something else might be assigned to a higher level. In the described example memory node 300 is named, “memory,” 307 in tag line 308. Memory 307 can be broken down into memory regions 301 and 302 described as, “MemRegion0” and “MemRegion1,” respectively. Each of memory regions 301 and 302 contains the properties, Address 310 and Attributes 311. (Attributes are any properties, such as writability, size, chip model number, etc., which may belong to a memory region.) The memory node 300 is preferably described by opening tag 305 and closing tag 306. The memory regions 301, 302 also can be described by opening and closing tags 309, 312, 313, 314, respectively.

In application of such systems, information often needs to be added to or removed from node 300. For example, information about the size of memory regions 301 and 302 might need to be added. In the described embodiment of the present invention, this can preferably be done without any problems caused to the consumer. The consumer can be any of a wide variety of components or subsystems that reads information from the memory regions. An example of a consumer may be a CPU connected to CCC 112 that might communicate through a client interface with memory node region 210 or an input/output subsystem that might need to know which data is in memory node 210. The consumer preferably will be coded in such a way that it conforms to an XML standard for information passing.

FIG. 4 is a graphical representation constructed according to one embodiment as disclosed herein of hardware properties as presented in FIG. 3 with an added property. XML would preferably allow the property, Size 400, to be added to each of memory regions 301 and 302 without making the other data 310 and 311 of each memory region 301 and 302 unusable to the consumer device or application. The consumer device or application, which had been a part of or in communication with the system since before Size 400 was added, will preferably not notice the change in properties and will continue to function consistently until it is programmed to do otherwise. This is because the consumer or client device or application can continue to pull out the information in Address 310 and Attributes 311 without pulling out the information in Size 400.

In another embodiment, XML representations may be utilized to allow users to access information about the hardware in their complex computing systems without having to obtain custom or proprietary programs. Because XML is a standard language, the embodiments described herein may preferably be adapted to serve hypertext transfer protocol (HTTP) directly from the firmware to a browser or other such display interface to display the system hardware properties. In yet another embodiment, the creator of the device tree may also create style sheets, such that he may control the view of the device tree as it would appear to a person using a browser or similar display interface to display hardware properties. Style sheets describe the display of documents in XML. For example, by employing style sheets, a user may designate certain colors for certain types of information or may choose to leave some information hidden. Style sheets may be created by the user in any of several style sheet creation languages, such as cascading style sheets (CSS) or extensible style sheet language transformations (XSLT).

In another embodiment, the vocabulary used in the firmware to describe information may be a set standard that allows for the interchange of information among many different users. For example, if Address 311, Attributes 312, and Size 400 (FIG. 4) are always named as such, and if the information in those fields is written in a standard way, a user would be able to exchange hardware properties with other users. It would also allow the user to better understand his own hardware properties for purposes of trouble-shooting, system design, or any other function that requires a user to be familiar with hardware properties. In another embodiment, the user may modify the firmware tables manually to add value to complex computing systems.

In still another embodiment, the firmware may be written such that tools that utilize information from the device tree may remain unmodified after changes are made to the firmware. This can be accomplished by describing and writing hardware properties consistently throughout several versions of the firmware. This embodiment results in minimal recoding of consumer software since most consumers will be able to process the same information though other information may be changed.

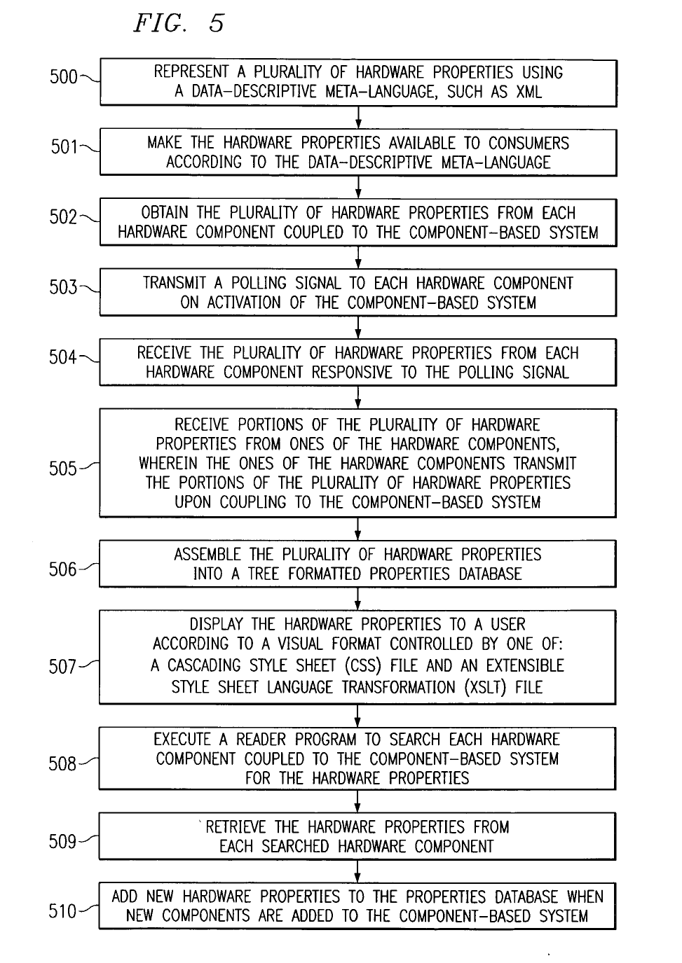

FIG. 5 is a flowchart illustrating an embodiment as described herein. In step 500, a plurality of hardware properties may be represented using a data-descriptive meta-language, such as XML. In step 501, the hardware properties may be made available to consumers according to the data-descriptive meta-language. In step 502, the plurality of hardware properties may be from each hardware component coupled to the component-based system. A polling signal may be transmitted to each hardware component on activation of the component-based system in step 503. In step 504, the plurality of hardware properties may be received from each hardware component responsive to the polling signal. In step 505, portions of the plurality of hardware properties may be received from ones of the hardware components, wherein the ones of the hardware components transmit the portions of the plurality of hardware properties upon coupling to the component-based system. In step 506, the plurality of hardware properties may be assembled into a tree formatted properties database. The hardware properties may be displayed to a user in step 507 according to a visual format controlled by one of a Cascading Style Sheet (CSS) file and an Extensible Style Sheet Language Transformation (XSLT) file. In step 508, a reader program may be executed to search the each hardware component coupled to the component-based system for the hardware properties. In step 509, the hardware properties may be retrieved from each searched hardware component. In step 510, new hardware properties may be added to the properties database when new components are added to the component-based system.

What is claimed is:

1. A method for managing a plurality of hardware properties in a component-based system comprising:
representing said plurality of hardware properties using a data-descriptive meta-language; and
making said hardware properties available to consumers according to said data-descriptive meta-language.

2. The method of claim 1 further comprising:
obtaining said plurality of hardware properties from each hardware component coupled to said component-based system.

3. The method of claim 2 wherein said obtaining step includes the steps of:
transmitting a polling signal to said each hardware component on activation of said component-based system; and
receiving said plurality of hardware properties from each hardware component responsive to said polling signal.

4. The method of claim 2 wherein said obtaining step includes:
receiving portions of said plurality of hardware properties from ones of said hardware components, wherein said ones of said hardware components transmit said portions of said plurality of hardware properties upon coupling to said component-based system.

5. The method of claim 1 further comprising:
assembling said plurality of hardware properties into a properties database.

6. The method of claim 5 wherein said properties database is stored in firmware of said component-based system.

7. The method of claim 5 wherein said properties database is configured in a tree format.

8. The method of claim 1 wherein said data-descriptive meta-language comprises Extensible Markup Language (XML).

9. The method of claim 8 wherein said hardware properties are displayed to a user according to a visual format controlled by one of:
a Cascading Style Sheet (CSS) file; and
an Extensible Style Sheet Language Transformation (XSLT) file.

10. The method of claim 2 further comprising:
executing a reader program to search said each hardware component coupled to said component-based system for said hardware properties; and
retrieving said hardware properties from said each searched hardware component.

11. The method of claim 5 further comprising:
adding new hardware properties to said properties database when new components are added to said component-based system.

12. A system for administration of devices connected to a multi-device electronic assembly comprising:
a memory comprising a device tree for arranging properties corresponding to said devices, wherein said properties are recorded in a data-descriptive computer language; and
a client interface for facilitating communication of said properties to clients of said multi-device electronic assembly.

13. The system of claim 12 further comprising:
a device interface for facilitating communication of said properties with said devices.

14. The system of claim 13 wherein said device interface signals each of said devices connected to said multi-device electronic assembly to communicate said properties associated with said device to said device tree.

15. The system of claim 13 wherein ones of said devices automatically communicate said properties associated with said device to said device tree on connection to said multi-device electronic assembly.

16. The system of claim 13 wherein said client interface includes administration software for searching each of said devices connected to said multi-device assembly to retrieve said properties associated with said device.

17. The system of claim 12 wherein said data-descriptive computer language comprises Extensible Markup Language (XML).

18. The system of claim 17 wherein said device tree is rendered to a user according to one of:
a Cascading Style Sheet (CSS); and
an Extensible Style Sheet Language Transformation (XSLT) file.

19. A system for administrating a plurality of device properties in a component-based system comprising the steps of:
means for representing said plurality of device properties using a data-descriptive language; and
means for making said device properties available to clients according to said data-descriptive language.

20. The system of claim 19 further comprising:
means for receiving said plurality of device properties from each component coupled to said component-based system.

21. The system of claim 20 wherein said means for receiving includes:
means for signaling said each component on activation of said component-based system; and
means for receiving said plurality of device properties from each component responsive to said means for signaling.

22. The system of claim 20 wherein said means for receiving includes:
means for collecting portions of said plurality of device properties from ones of said each component, wherein said ones of said each component transmits said portions of said plurality of device properties upon coupling to said component-based system.

23. The system of claim 19 wherein said data-descriptive language comprises Extensible Markup Language (XML).

24. The system of claim 23 further comprising:
means for displaying said plurality of device properties to a user responsive to one of:
a Cascading Style Sheet (CSS); and
an Extensible Style Sheet Language Transformation (XSLT) file.

25. The system of claim 19 wherein said plurality of device properties is represented in said data-descriptive language using a tree format.
